(19) United States
(12) Patent Application Publication
(10) Pub. No.: US 2016/0070112 A1
(43) Pub. Date: Mar. 10, 2016

(54) ADJUSTABLE OPTICAL STEREOSCOPIC GLASSES

(71) Applicants: Jay Song, Aliso Viejo, CA (US); Lishang Zhou, Beijing (CN)

(72) Inventors: Jay Song, Aliso Viejo, CA (US); Lishang Zhou, Beijing (CN)

(21) Appl. No.: 14/478,945

(22) Filed: Sep. 5, 2014

(51) Int. Cl. G02B 27/22

(52) U.S. Cl. CPC G02B 27/2242; G02B 27/2235

(57) ABSTRACT

The present invention relates to optical stereoscopic glasses which achieves simple structure, adjustable, cost effective, strong sense of adaptation and harmless to eyes, which allows to perceive stereoscopic vision when viewing the screen plane of movie, TV, computer and cellular phone.

### CLAIM OF BENEFIT OF FILING DATE

This application claims the benefit of the filing date of U.S. Provisional Application Ser. No. 61/874,366 titled “Adjustable Optical Stereoscopic Glasses” filed on Sep. 6, 2013, which is incorporated herein by reference for all purposes.

### FIELD OF THE INVENTION

The present invention relates to optical stereoscopic glasses which achieves simple structure, adjustable, cost effective, strong sense of adaptation and harmless to eyes, which allows to perceive stereoscopic vision when viewing the screen plane of movie, TV, computer and cellular phone.

### BACKGROUND OF THE INVENTION

There are various techniques for viewing 3D movie or TV, most of them by utilizing binocular disparity, the key factor and the most intense to stereoscopic vision. The techniques use of anaglyph glasses, polarized glasses, LED glasses, shuttered glasses, split image (adjacent side by side image on screen) glasses, lenticular screen, interleaved screen, process separation screen, adaptive stereoscopic TV screen, and so on, to achieve stereoscopic vision. Filtered through the abovementioned glasses while viewing the produced 3D movie or TV, the left-eye scene imaging onto the left-eye retina, the right-eye scene imaging onto the right-eye retina, the brain fuses and synthesizes the two images characterized by screen parallax to form a type of stereoscopic images, the stereoscopic viewing is therefore achieved.

There are many elements to bring in a sense of scene for stereoscopic visual, which includes the magnitude of object, relative position, object masking, relative motion, spatial perspective, binocular vergence, binocular disparity, and motion effect, etc., but binocular disparity is the most important factor and the most intense stereoscopic signal to generate stereoscopic visual, which is interpreted as the offset of human eyes, imaging of the observed object on left-eye retina and right-eye retinal are slightly different, after processing by the brain, the spatial sense and stereoscopic sense is restored. That is, when the left-eye retina imaging and the right-eye retinal imaging appear specific differences, it generates stereoscopic visual. Simultaneously, the eyes responding behavior to the screen parallax and other stereoscopic visual elements is to accommodate (focus), convergence or divergence adjustment. But, when watch the planar screen of movie, TV, computer or cellular phone, binocular disparity presents a negative effect to 3D visual, at this point, the binocular disparity tells the brain “It is watching a planar image!” of which the strongest negative effect to 3D visual overlaps other 3D information. Therefore, when viewing the planar image, it becomes to realization and direction of stereoscopic visual viewing by eliminating the negative effect to 3D visual due by binocular disparity, it will strengthen the overlapped other stereoscopic information by reducing or eliminating the negative effect to 3D vision due by binocular disparity, and results in the planar visual transition into the stereoscopic vision.

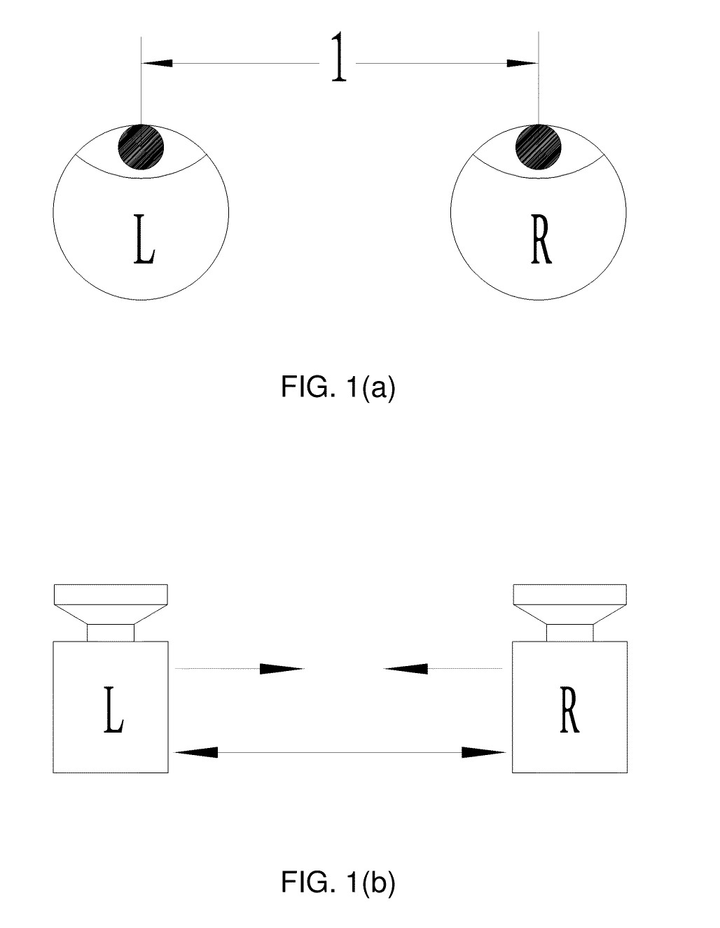

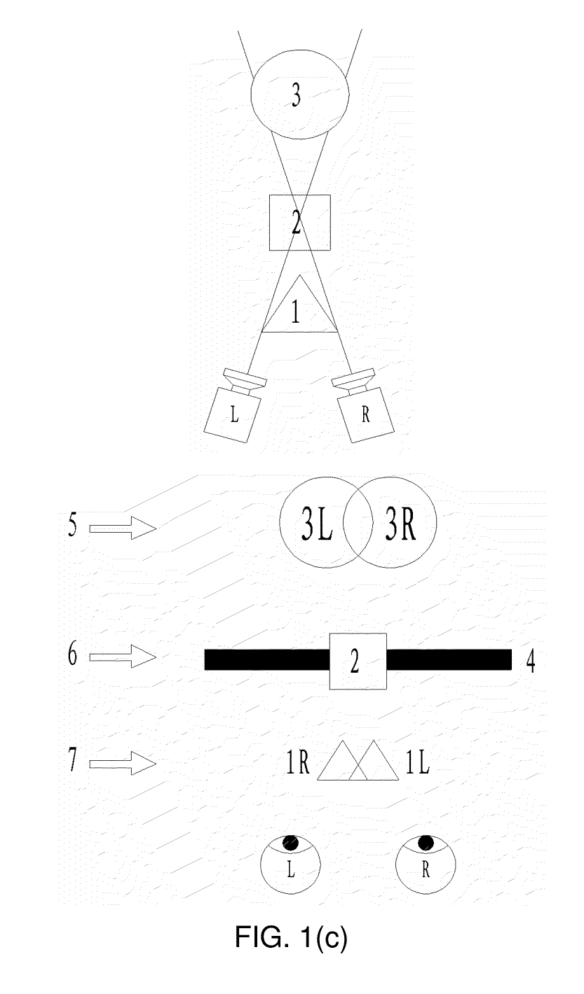

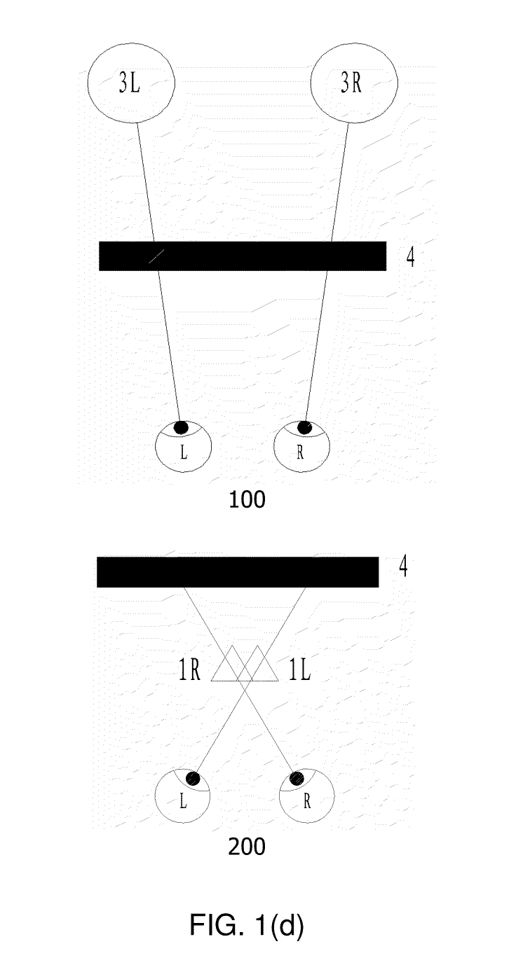

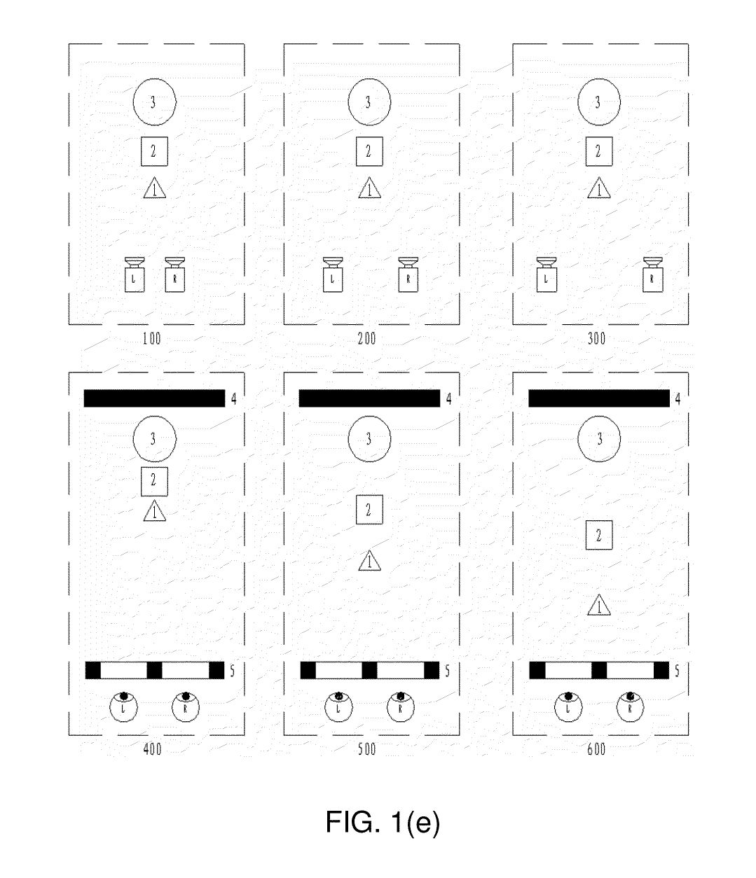

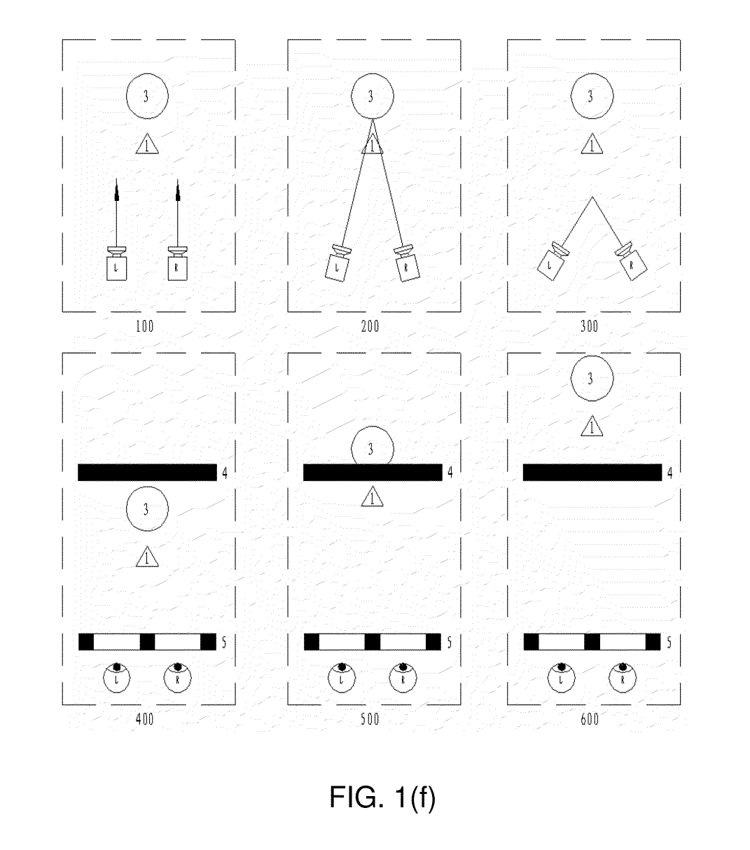

The produced 3D movie or TV by parallax exists an insurmountable disadvantage of which audiences have various capability to the parallax, too small, moderate, or excessive parallax often appear in stereoscopic vision (FIG. 1(e)), it even beyond the parallax limitation to fuse human binocular vision, results in excessive stereoscopy, distortion and ghosting image. Some people cannot even adapt to current iMax cinema movie, as it causes dizziness, headache, vomiting reaction due by over parallax limitation, some people is easy to produce visual fatigue and eyestrain while viewing, or even visual injury while long viewing. At present, the technical characteristics to produce stereo product is to go through multiple layers of depth perception (usually 4-8 layers) for stereoscopic effect, but careful viewing will observe the stratified distortion sense. In the real world, the picture of depth perception is a continuous natural extension, in other words, it shows the picture depth layer partitioning tends to infinite, for realization, neither current technical means nor tools are capable for completion and implementation. How to solve above issues, to make the stereoscopic glasses satisfy the needs by most people which can enjoy the full stereoscopic visual without beyond the binocular disparity limitation, it has become the primary issue to face in design of stereoscopic visual product.

### SUMMARY OF THE INVENTION

The present invention relates to adjustable optical stereoscopic glasses. When use the glasses to watch 2D screen of movie, TV, computer or cellular phone, it is able to induce 3D illusion and enjoy stereoscopic visual, feels the depth perception as continuous extension of the natural space, namely the layer division to the infinite, and through the virtual 3D design to make the brain feels there is a considerable difference of the image on left-eye retina and right-eye retina by decomposition of the 2D picture, forms a strong binocular disparity and obtains the stereoscopic visual. The principle of present invention is to convert refraction by optical lenses into parallax, by adjusting refraction, to achieve optimal fusing of human binocular parallax. It achieves viewing difference and restores depth perspective by eliminating too small or excessive stereoscopic, distortion, ghosting image, dispersion, and the eyes turning inward or outward by strabismus, it will not induce eyestrain or visual injury when long watching the stereoscopic screen of movie, TV, computer, etc.

The present invention is to achieve a simple technical approach of stereoscopic viewing while watching the 2D screen of movie, TV, computer, cellular phone. This invention avoids improper use of binocular disparity, the key and the most intense element of stereoscopic vision, to causes too small parallax for less stereopsis, too large parallax or even beyond parallax limitation for fusing human binocular vision, causes eyestrain, visual injury and distortion by excessive stereoscopy, as well as the excessive background viewing when stereoscopic image is behind the screen to force the eyes turning outward which cause both unnatural and extremely uncomfortable. It weakens the negative effect to 3D vision by binocular disparity while focusing on the screen plane of movie, TV, computer or cellular phone.

The structure of the adjustable optical stereoscopic glasses is the left-eye and right-eye lenses made of combination of optical prisms, lens, curved mirrors or a planar mirrors, which represents the scheme of hypostereo by negative screen parallax, hyperstereo by positive screen parallax, etc. When left-eye and right-eye seeing through the lenses, the spatial displacements of objectives take place which eliminate the negative effect to 3D vision by binocular disparity when planar focusing, the depth perception is recovered. The design of combination the left and right lenses has considered the follows: (a) eliminating dispersion; (b) no diopter; (c) the thinnest lens combination; (d) strong refractive effect; (e) parallax adjustable; (f) no image deformation and distortion; (g) parallax within brain's fusing acceptance range.

To comfort and practicality, the glasses is made of solid optical material characterized by light weight, high transparency, and high refractive index, the thickness range of lenses from 1 mm to 100 mm, the apex angle is greater than zero and less than 45 degree, to achieve the stereoscopic visual for viewing.

### DETAILED DESCRIPTION OF THE DRAWING

The features and inventive aspects of the present invention will become more apparent upon reading the following detailed description, claims, and drawings, of which the following is a brief description.

FIG. 1 illustrates the series of basic concepts about stereoscopic vision: (a) interocular distance; (b) parallax effect; (c) screen parallax; (d) convergence and divergence; (e) stereo base; (f) convergence and 3D imaging space.

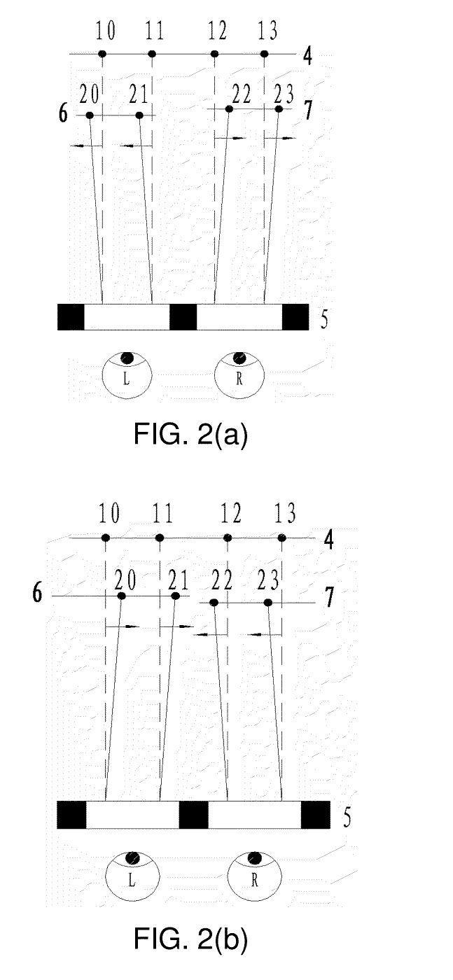

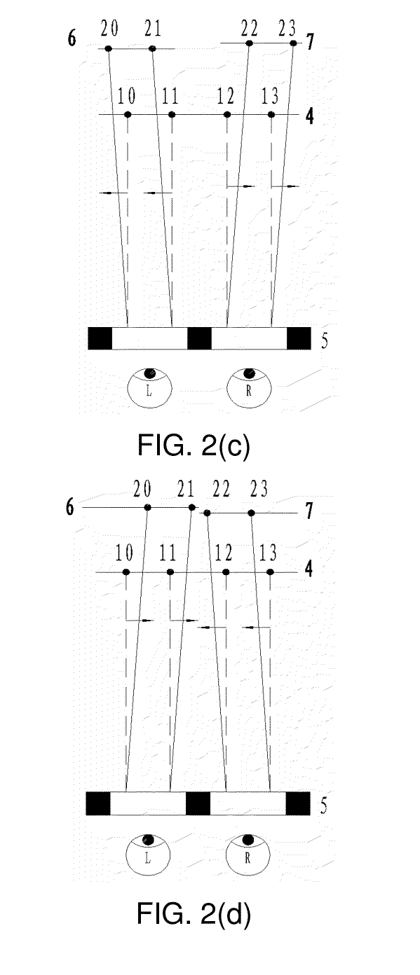

FIG. 2 shows four standard models of stereo imaging by the invented adjustable optical stereoscopic glasses when viewing plane video or image. (a) represents the negative screen parallax hypostereo vision of which the image plane is forward from the screen plane; (b) represents the hyperstereo vision of which the image plane is forward from the screen plane; (c) represents the hypostereo vision of which the image plane is backward from the screen plane; (d) represents the positive screen parallax hyperstereo vision of which the image plane is backward from the screen plane.

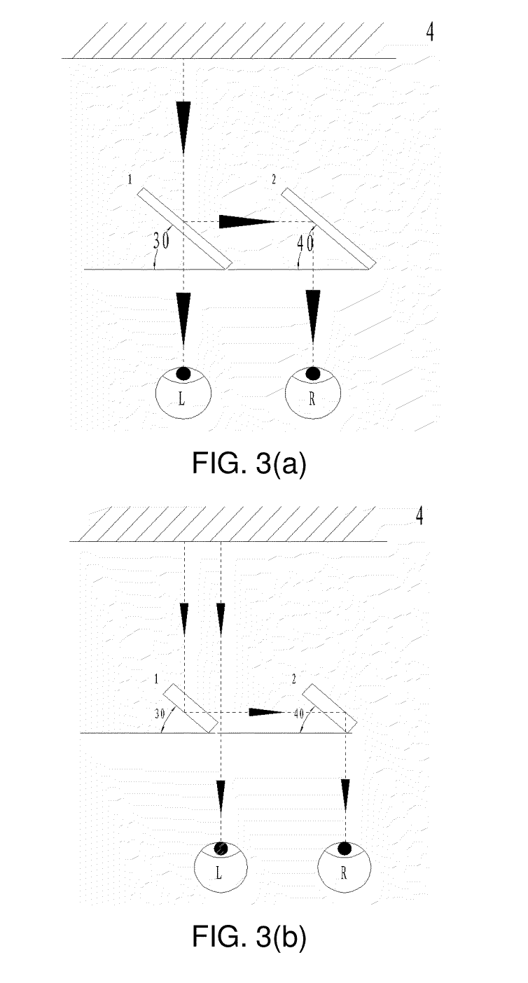

FIG. 3 (a) shows by using of one semitransparent and semireflection plane mirror and one plane mirror to eliminate negative effect to 3D vision by binocular parallax when focusing on plane screen; (b) shows by using of two plane mirrors to eliminate negative effect to 3D sense by binocular disparity when focusing on plane screen.

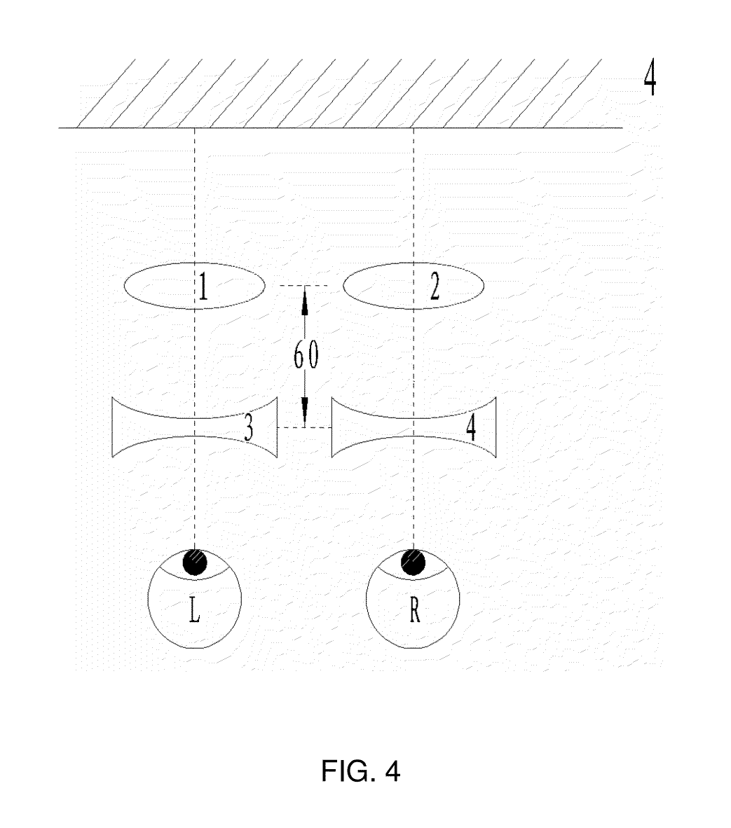

FIG. 4 shows by using of Galilean telescope to eliminate negative effect to 3D sense by binocular disparity when focusing on plane screen.

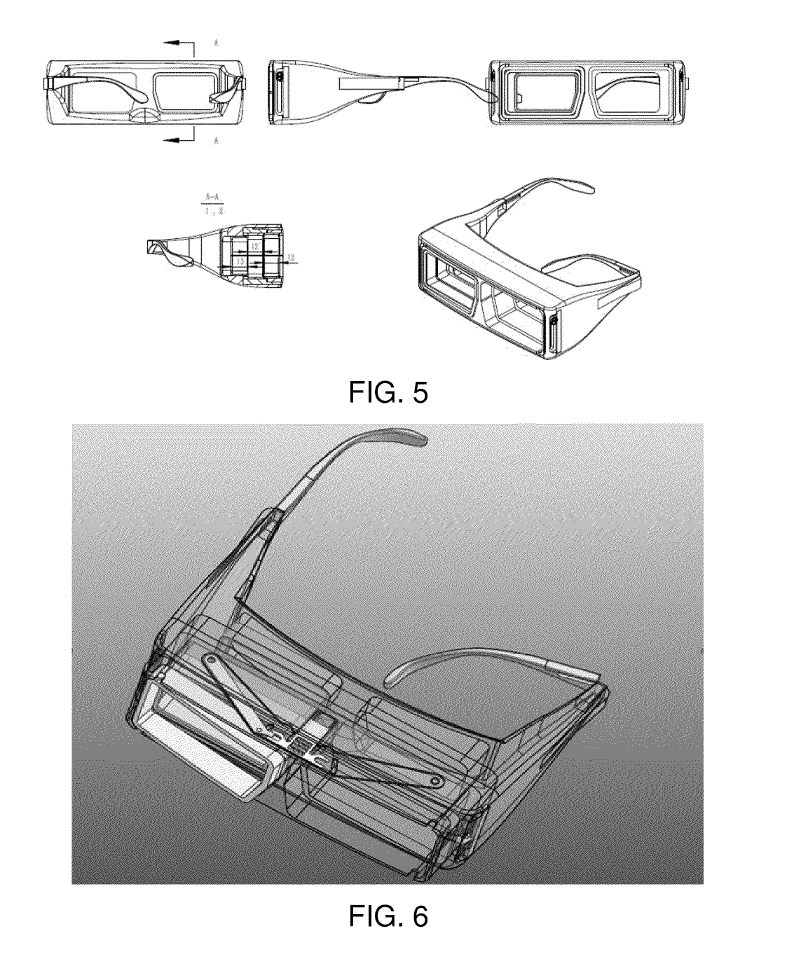

FIG. 5 shows the views and sectional views of commercially designed adjustable optical stereoscopic glasses.

FIG. 6 shows the 3D structural view of the adjustable optical stereoscopic glasses.

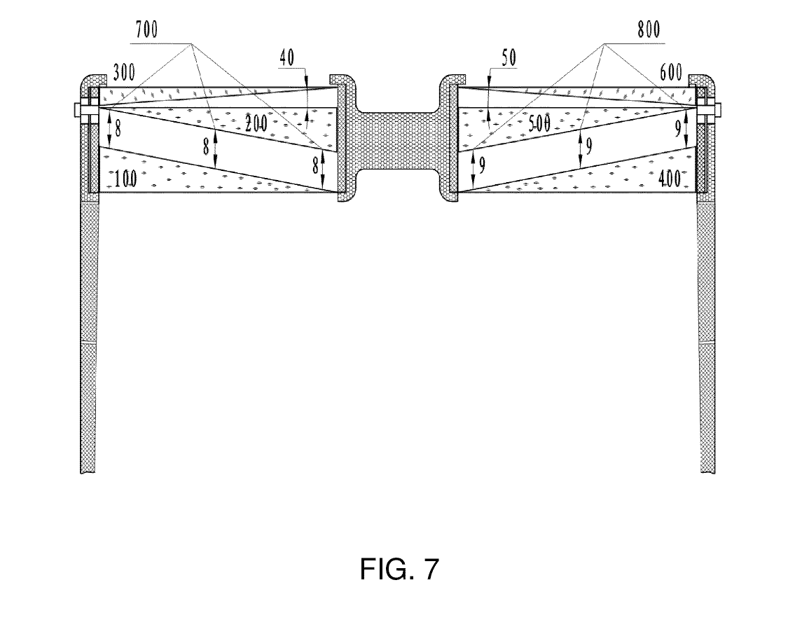

FIG. 7 shows the schematic sectional view of the adjustable optical stereoscopic glasses of which the lenses are made of triangular prisms.

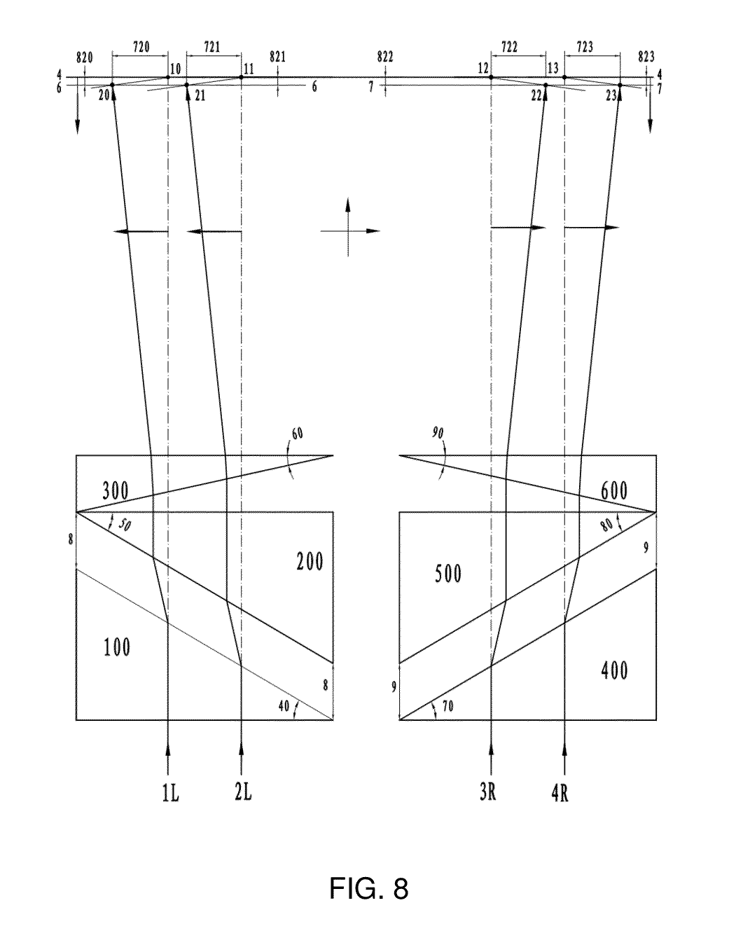

FIG. 8 illustrates the intended spatial displacement of scene and imaging for the two opposite triangular prisms separated by distance “8” and “9” by superimposed another triangular prism, which introduces hyperstereo viewing.

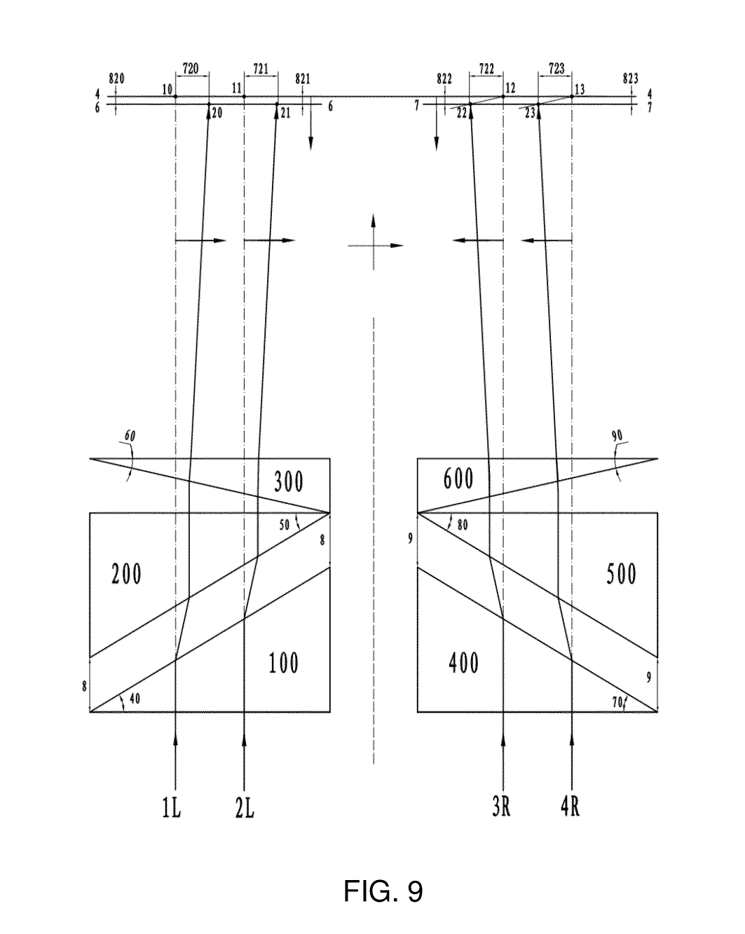

FIG. 9 illustrates the intended spatial displacement of scene and imaging for the two opposite triangular prisms separated by distance “8” and “9” by superimposed another triangular prism, which introduces hypostereo viewing.

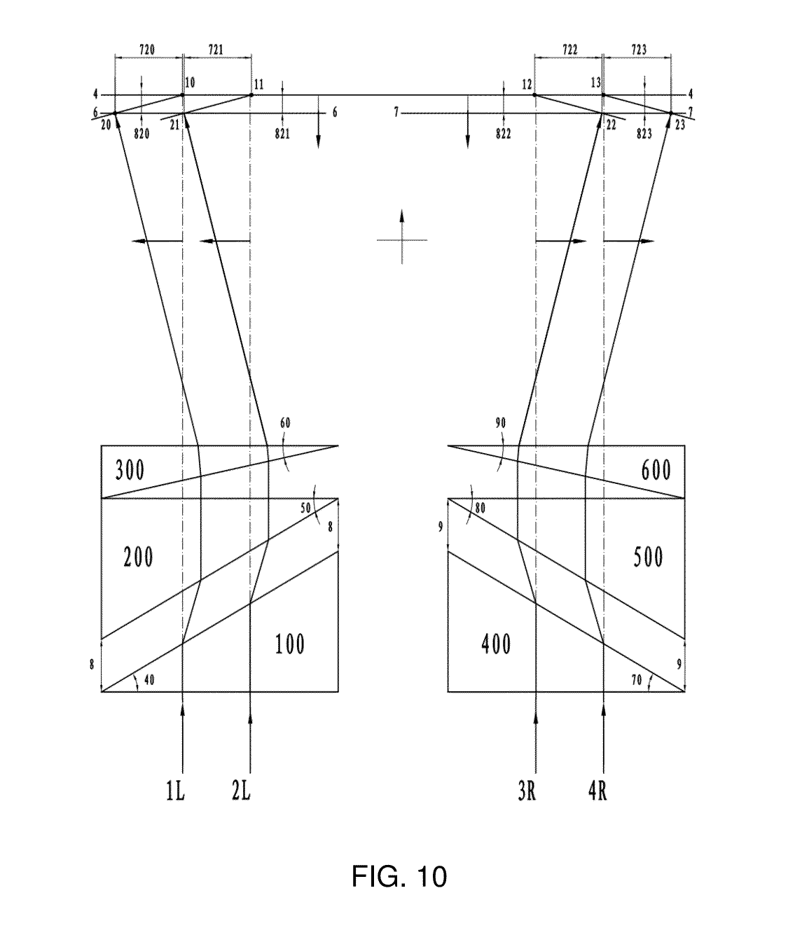

FIG. 10 illustrates the intended spatial displacement of scene and imaging for the two opposite triangular prisms separated by distance “8” and “9” by superimposed another triangular prism, which introduces hyperstereo viewing.

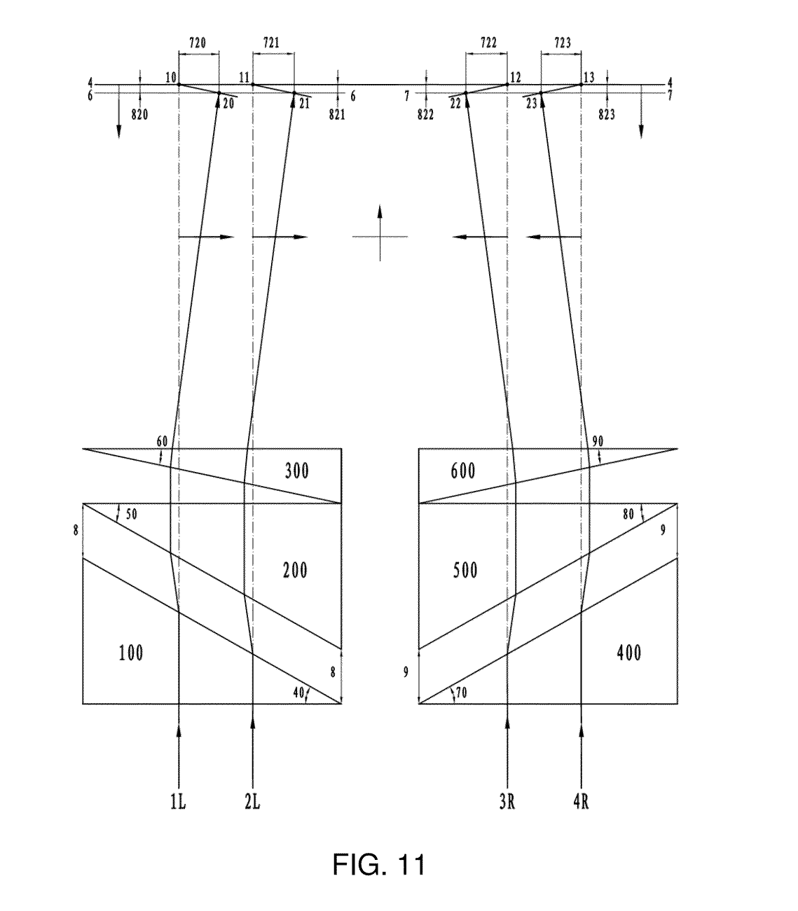

FIG. 11 illustrates the intended spatial displacement of scene and imaging for the two opposite triangular prisms separated by distance “8” and “9” by superimposed another triangular prism, which introduces hypostereo viewing.

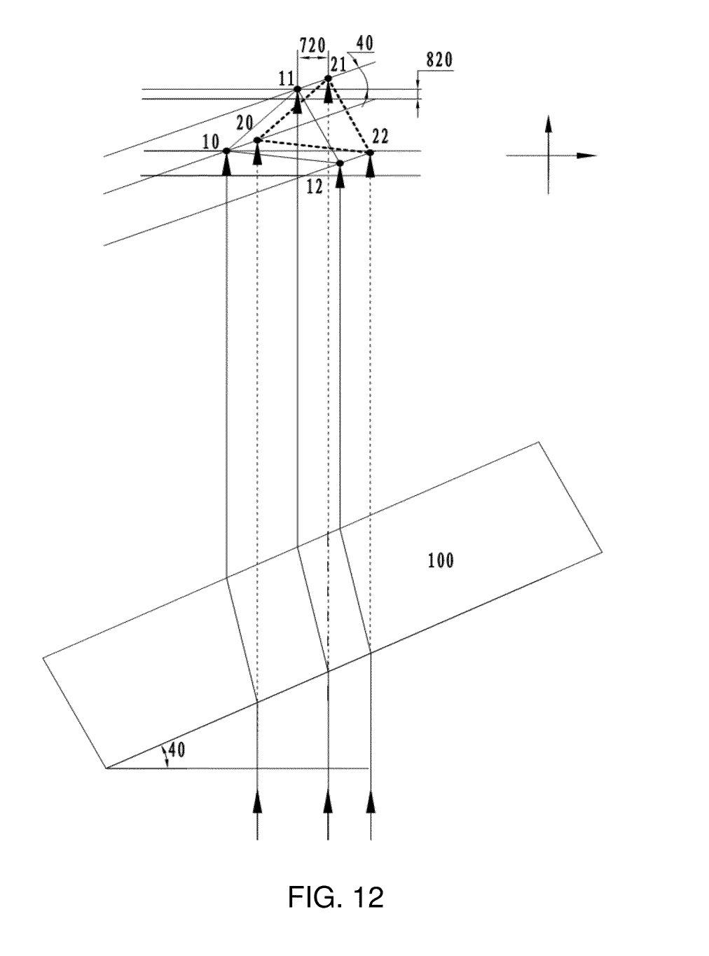

FIG. 12 illustrates the parallel light passing through the rectangular prism which is angled to horizontal and image occurring spatial displacement.

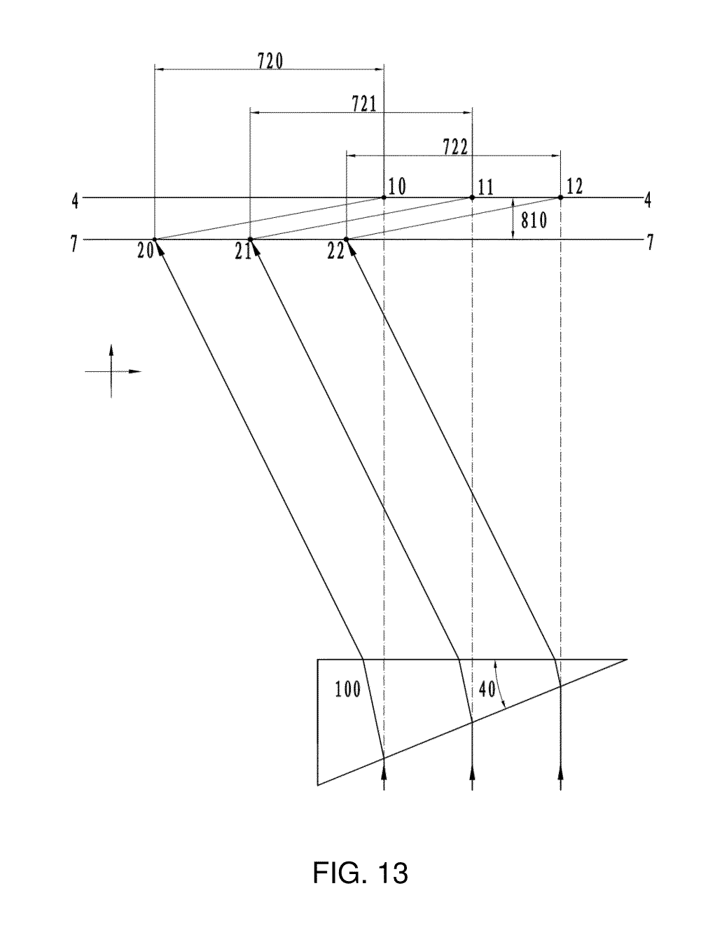

FIG. 13 illustrates the parallel light passing through triangular prism image occurring refraction and spatial displacement.

FIG. 14 illustrates the two opposite triangular prisms separated by a distance, the triangular prism bottom surface is horizontal. It is concluded the deeper the separation gap, the greater the displacement.

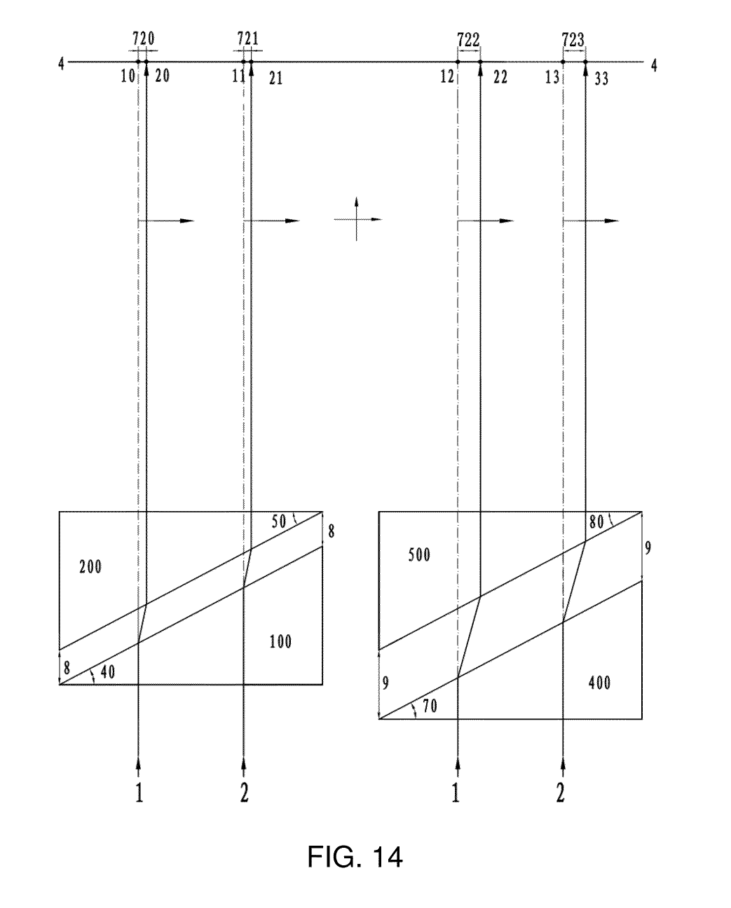

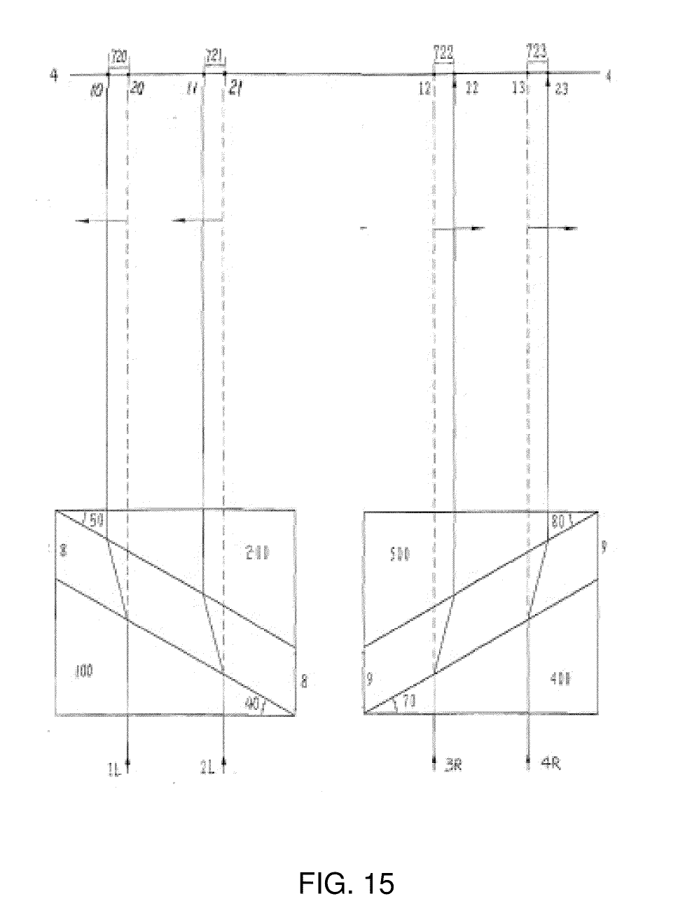

FIG. 15 illustrates the set of two opposite triangular prisms which separated by a distance, the right lenses has the same structure of the two triangular prisms referring to FIG. 14, the left lenses is positioned a mirroring to the right lenses.

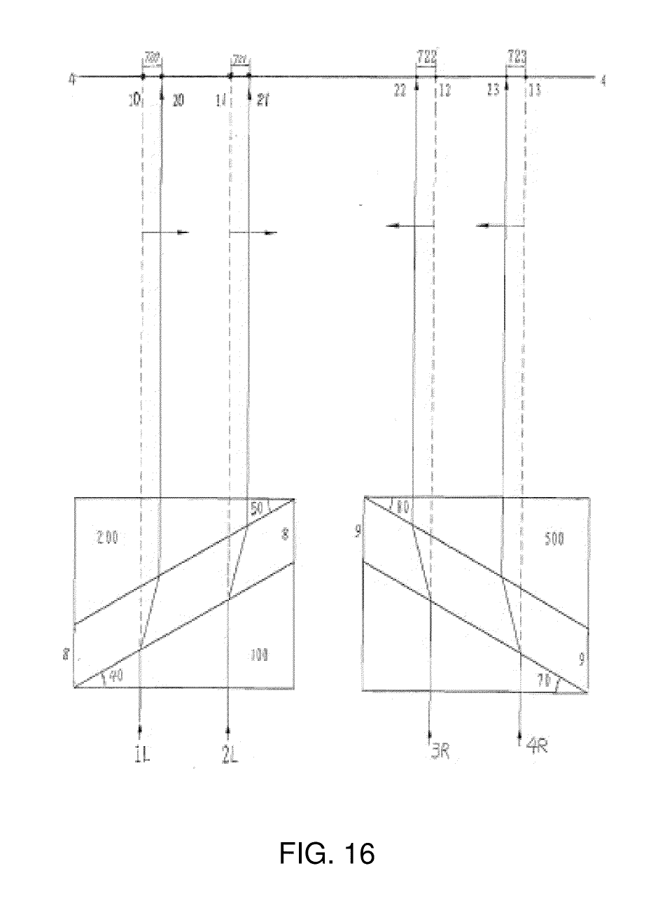

FIG. 16 illustrates the set of two opposite triangular prisms which separated by a distance, the structure of the set of two opposite triangular prisms is similar to FIG. 15, except by swap the left and right lenses.

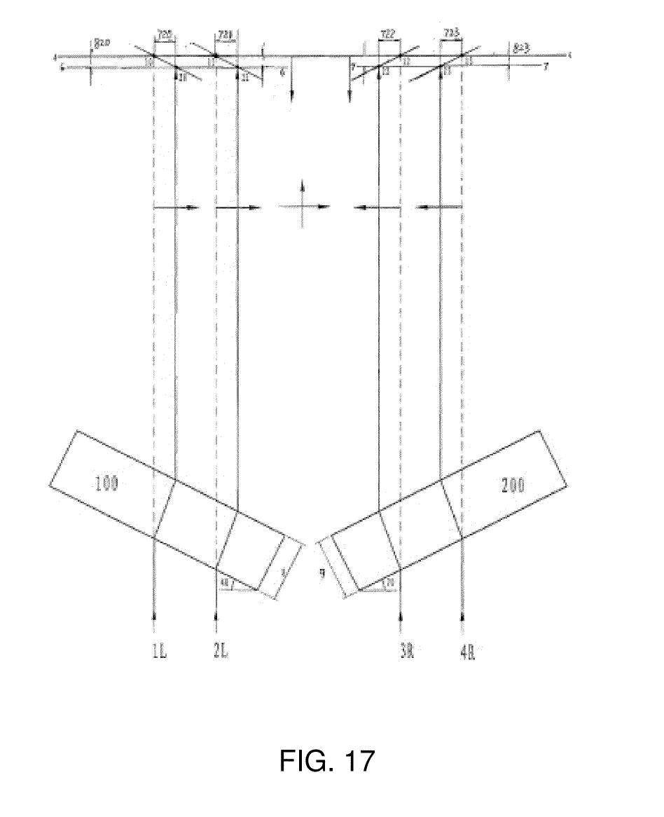

FIG. 17 illustrates the rectangular prism or planar mirror structured by following certain rules to refract the light path when parallel lights passing through the rectangular prisms in which labeled angle “40” and “70” to the binocular axis or horizontal surface, it appears hypostereo viewing.

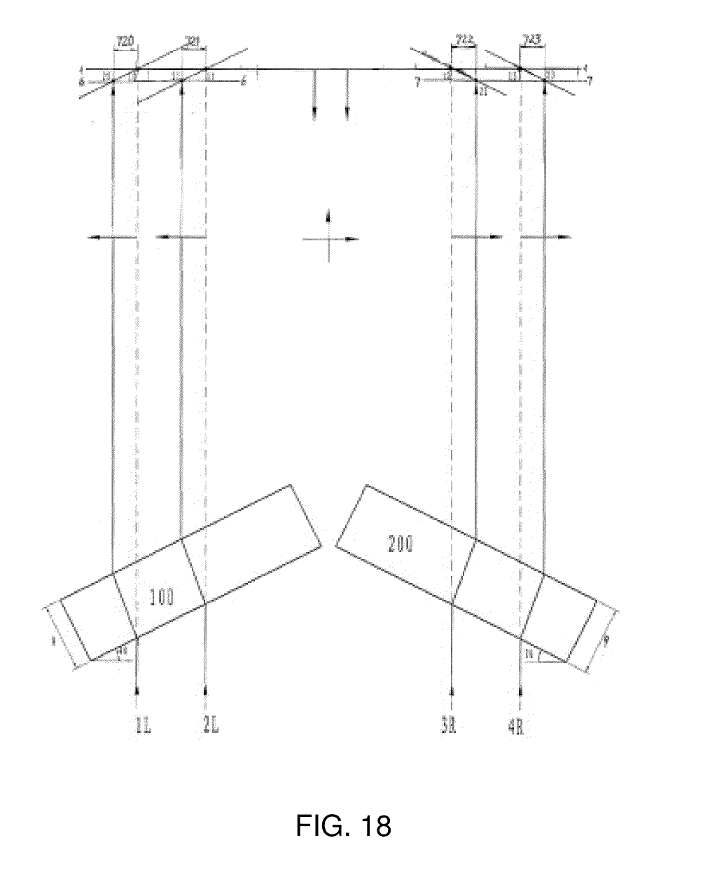

FIG. 18 illustrates the rectangular prism or planar mirror structured by following certain rules to refract the light path when parallel lights passing through the rectangular prisms in which labeled angle “40” and “70” to the binocular axis or horizontal surface, it appears hyperstereo viewing.

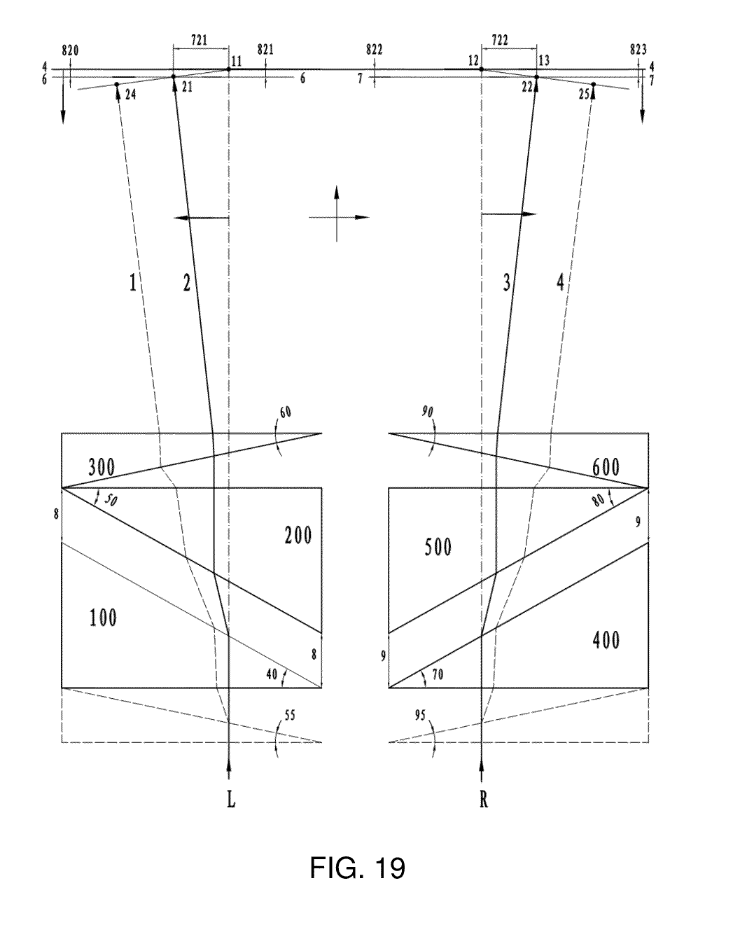

FIG. 19 illustrates the comparison of FIG. 8 and other combination of lenses structure of which, in this case, by superimposing another triangular prism to the bottom of the lenses in FIG. 8, it is concluded that the new structure yields more spatial displacement and enhanced hyperstereo viewing.

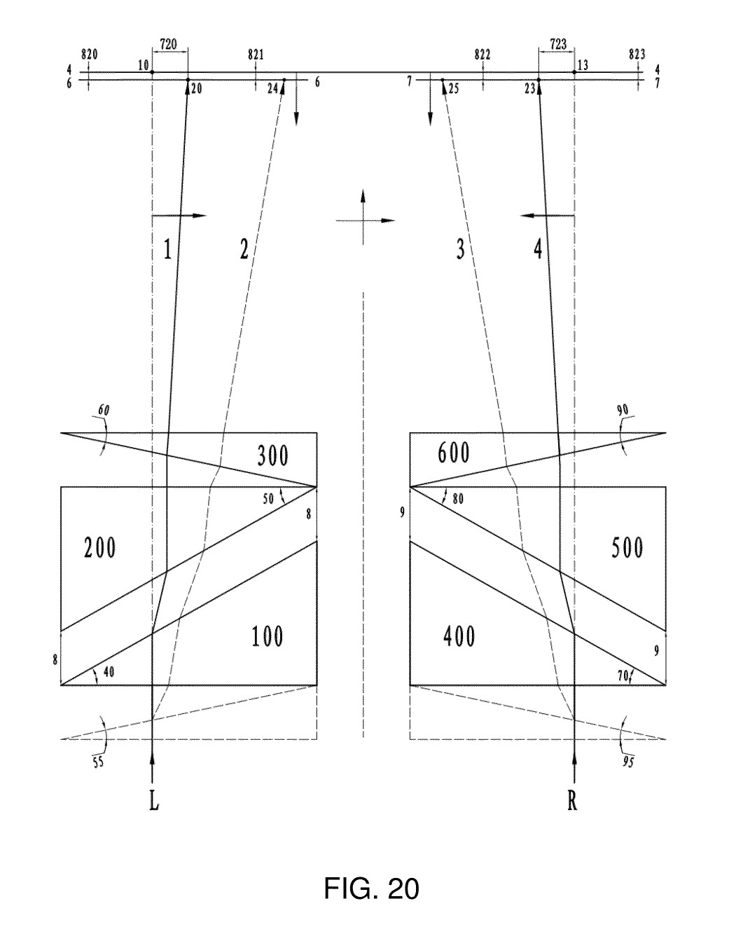

FIG. 20 illustrates the comparison of FIG. 9 and a new lenses structure of which by superimposing another triangular prism to the bottom of the lenses in FIG. 9, it is concluded that the new structure yields more spatial displacement and enhanced hypostereo viewing.

### DESCRIPTION OF THE PREFERRED EMBODIMENT

At present, the technique for viewing 3D movie or TV by using of anaglyph glasses, polarized glasses, LED glasses, shuttered glasses, split image (adjacent side by side image on screen) glasses, lenticular screen, interleaved screen, process separation screen, adaptive stereoscopic TV screen, and so on, the principle of producing 3D movie or TV is to simulate the offset of human eyes (the interocular distance or the normal base), to shoot by two cameras which separately positioned with same elevation and consistent to each other in order to reflect the offset difference. Filtered through the abovementioned glasses when viewing, the left-eye scene imaging onto the left-eye retina, the right-eye scene imaging onto the right-eye retina, the brain fuses and synthesizes the two images characterized by screen parallax to form a type of stereoscopic images, the stereoscopic viewing is therefore achieved.

FIG. 1(a) illustrates the interocular distance or the normal base which is about 60 mm-65 mm in general, the eye “L” represents the left-eye, the eye “R” represents the right-eye. FIG. 1(b) illustrates an attempt to replicate what we see with our two eyes by adjusting the base between cameras, the camera “L” represents the left camera, “R” represents the right camera. FIG. 1(c) indicates the image of object “2” fall in the screen “4” while shooting was focusing on the object “2”,“6” defines zero screen parallax; the near image of object “1” is shifted to right as “1L” for the left-eye viewing and shifted to left as “1R” for the right-eye viewing, “7” defines negative screen parallax region for images appear in front of the screen; the far image of object “3” is shifted to left as “3L” for the left-eye viewing and shifted to right as “3R” for right-eye viewing, “5” defines positive screen parallax for images appear in the region behind the screen.

In the real world, our eyes focus (accommodate) and converge at a single point, when 2D viewing, our eyes focus (accommodate) and converge onto the screen plane; when 3D viewing, our eyes always accommodate on the screen but converge anywhere along the axis of our eyesight. As shown in FIG. 1(d), the eye “L” represents the left-eye, the eye “R” represents the right-eye, “4” represents the screen. The portion 200 indicates extreme convergence can cause the eyes to turn excessively inward as a result of the brain will not be able to fuse the “1L” and “1R” images of the object “1” of which “1L” is yielded by the left-eye and “1R” is yielded by the right-eye; The portion 100 indicates divergence far exceeds the human interocular distance which causes the eyes to turn outward, yields unnatural and extremely uncomfortable and results in the brain will not be able to fuse the “3L” and “3R” images of the object “3” of which “3L” is yielded by the left-eye and “3R” is yielded by the right-eye, and quickly experience eyestrain and fatigue.

FIG. 1(e) illustrates two cameras by keeping parallel but adjusting stereo base, we are able to dynamically increase and decrease the depth in the 3D imaging world, the large the stereo base, the more depth eye captured. The eye “L” represents the left-eye, the eye “R” represents the right-eye; the camera “L” represents the left camera, the camera “R” represents the right camera; “1”, “2”, “3” represent three different objects; “4” represents the screen, “5” represents the stereoscopic glasses. As shown in FIG. 1(e), the portion 100 is to simulate our normal eyes watching the spatial distribution of the objects, the portion 400 represents the correlated 3D viewing; the portion 200 represents to increase the stereo base, the portion 500 represents the more depth captured in the correlated 3D viewing; the portion 300 represents to further increase the stereo base, the portion 600 represents the more and more depth captured in the correlated 3D viewing. FIG. 1(f) illustrates two cameras by keeping stereo base but adjusting convergence, we are able to determine where the image appears in relation to the screen. Convergence can be adjusted by toeing-in (an inwardly-angled adjustment) of the cameras. The eye “L” represents the left-eye, the eye “R” represents the right-eye; the camera “L” represents the left camera, the camera “R” represents the right camera; “1”, “3” represent two different objects; “4” represents the screen, “5” represents the stereoscopic glasses. As shown in FIG. 1(f), the portion 100 represents two cameras are parallel, the portion 400 represents the correlated 3D image will be in front of the screen “4”; the portion 200 represents converge on the object “3”, the portion 500 represents the object “3” appears on the screen “4” and the image of “1” appears in front of the screen “4”; the portion 300 represents converge in front of the objects, the portion 600 represents all the objects imaging appear to behind the screen “4”.

FIGS. 2(a), 2(b), 2(c), 2(d) show four stereoscopic imaging models of which the lenses of the invented adjustable optical stereoscopic glasses consists of various combination of lens. The eye “L” represents the left-eye, the eye “R” represents the right-eye; “4” represents the real screen or scene plane, “5” represents the stereoscopic glasses, “6” represents the imaging plane of the screen “4” by left-eye, “7” represents the imaging plane of the screen “4” by right-eye; point “10” and point “11” are two objective points on screen “4” for left-eye viewing, point “20” and point “21” are correlated two imaging points onto the imaging screen “6” by left-eye viewed; point “12” and point “13” are two objective points on the screen “4” for right-eye viewing, point “22” and “23” are correlated imaging point on image screen “7” by right-eye viewed. FIG. 2(a) represents the first imaging model of the stereoscopic glasses, it forms hypostereo vision of which the image plane is forward from the screen plane to yield backward spatial displacement by referring to the eyesight direction, the displacement of the left-eye image to the left and the right-eye image to the right; FIG. 2(b) represents the second imaging model of the stereoscopic glasses, it forms hyperstereo vision of which the image plane is forward from the screen plane to yield backward spatial displacement by referring to the eyesight direction, the displacement of the left-eye image to the right and the right-eye image to the left; FIG. 2(c) represents the third imaging model of the stereoscopic glasses, it forms hypostereo vision of which the image plane is backward from the screen plane to yield forward spatial displacement by referring to the eyesight direction, the displacement of the left-eye image to the left and the right-eye image to the right; FIG. 2(d) represents the forth imaging model of the stereoscopic glasses, it forms hyperstereo vision of which the image plane is backward from the screen plane to yield forward spatial displacement by referring to the eyesight direction, the displacement of the left-eye image to the right and the right-eye image to the left.

Binocular disparity is the most important factor and the most intense element to generate stereoscopic visual, which is interpreted as the position difference of the eyes (interocular distance or normal base), there is tiny difference from two eyes, imaging of the observed object on left-eye retina and right-eye retinal are slightly different, after processing by brain, the space and stereoscopic sense is yielded. That is, when the left-eye retina imaging and the right-eye retinal imaging appear specific differences, it generates stereoscopic vision. Stereoscopic visual are viewed differently from real-world images, stereoscopic parallax has certain rule and behavior to follow, such as: (1) the depth in screen will be dynamically increased when increasing the stereo base (See FIG. 1(e)), vice versa; (2) simultaneously manipulating the convergence and the stereo base give control over the depth and placement of the image in 3D space (See FIGS. 1(e),1(f)); (3) spatial displacement of the image can be controlled through the convergence e.g. the focusing point (See FIG. 1(f)); (4) zero screen parallax refers to image appears at the screen plane, the left-eye and right-eye images are overlapped (See FIG. 1(c)); positive screen parallax refers to objective image appears behind the screen and the image is shifted to the left for the left-eye and to the right for the right-eye (See FIG. 1(c), FIG. 2(c)); negative screen parallax refers to objective image appears in front of the screen and the image is shifted to the right for the left-eye and to the left for the right-eye (See FIG. 1(c), FIG. 2(b)); (5) to avoid, when viewing 3D our eyes always focus on the screen but converge anywhere along the eyesight, extreme convergence which can cause eye to turn excessively inward, and the amount of background divergence far exceeds human interocular distance, it can cause the eyes to turn excessively outwards (See FIG. 1(d)).

When watch 2D movie or TV, even the big scene and in certain viewing distance, it cannot avoid a sense of watching planar image, the reason is that when the eyes focus on movie or TV screen plane (slightly curved IMAX movie screen similar to plane screen) the zero screen parallax tells brain “This is a planar image!”, which means parallax introduces the negative effect to the stereoscopic sense while focusing on TV or movie screen, although the big screen, magnitude of object, object masking, relative motion, spatial perspective and other stereoscopic information still exist, but are severely weakened by the stronger parallax while focusing on screen plane. Therefore, when normally watch the 2D movie or TV, the viewing has the planar vision.

There is discrepancy between the 2D and 3D screen viewing, when eyes view the 2D screen, both the convergence point and focal point fall on the screen plane, when eyes view the 3D screen, the focal point always fall on the screen plane and the convergence point fall in the depth direction along the eyesight as shown in FIG. 1(f), namely the convergence point or convergent plane and the focal point or focal plane of the scene existence of spatial depth displacement. Thus, the discrepancy between watching 2D screen and 3D screen is the depth perception vanishing in 2D screen but existing in 3D screen. The difference between watching the real scene and 2D screen is when viewing the 2D scene on screen, the zero parallax strongly tells the brain “This is a planar view”, even if the 3D sense of depth exists in the scene such as space perspective, relative motion, eyes vergence, and motion disparity, even in a certain viewing distance, it cannot avoid the feeling of planar viewing by the brain, which is strong negative effect to 3D sense (planar view effect) by binocular disparity when focusing on plane screen. We can perform a few experiments to verify, eliminate or reduce the negative effect to 3D visual by binocular disparity when focusing on planar image: (a) use both hands to assist the experiment for obscuration, when eyes obscured, the depth perception recovers while watching the scene less than a complete picture and picture frame but anything outside, the brain intuition is a true 3D scene. Exam.2, use of the optical principle and method to eliminate the negative effect to 3D visual of binocular parallax when viewing the planar image, to induce stereoscopic vision, such as: (a) A 45° angled semitransparent and half reflection plane mirror is placed in front of the left-eye for left-eye sight, and a 45° angled plane mirror is placed in front of the right-eye for right-eye sight (left and right-eye interchangeable, see FIG. 3 (a)); (b) A plane mirror is located above or below the left-eye, the left-eye directly see the screen, and same to (a), a 45° angled plane mirror is placed in front of the right-eye for right-eye sight (left and right-eye interchangeable, see FIG. 3 (b)). The two methods turn negative parallax effect to zero, leave other 3D elements existence, stereoscopic vision presents. (c) By using of the principle of Galilean telescope to view the planar image (FIG. 4), due to the imaging is an illusion, to some extent, which weaken the negative effect to 3D visual of binocular disparity, leave other 3D elements existence, stereoscopic vision presents. Thus, the most direct solution to seek recovery of depth perception is the brain intuition the convergence points or convergent planes of objects in the scene are not the same as the real screen plane (the focal plane of the eyes), if realized, the depth perception restored, the stereoscopic visual existence.

The invention refers to the left-eye and the right-eye lenses structure of the adjustable optical stereoscopic glasses which made of the combination of optical prisms, lens, curved mirrors or a planar mirrors. As shown in FIG. 2(a), FIG. 2(b), FIG. 2(c), FIG. 2(d), when viewing the screen scene through different structured stereoscopic glasses, the imaging positions of convergence points of objects are away from the real screen position, outward, stay in or inward from the real screen, which eliminates the negative effect to 3D sense by parallax when focusing on screen plane, to make all stereo factors such as spatial perspective, relative motion, eyes vergence, etc have a strong role in the brain, the depth perception is recovered. Because the lenses of stereoscopic glasses of the invention is combination of optical prisms, lens, curved mirrors or plane mirrors, when watching the object in the scene through the lenses, the light ray is refracted, the image point happened in the space displacement, as shown in FIG. 2(a), FIG. 2(b), FIG. 2(c), FIG. 2(d). Due by the existence of diopter in lens and curved mirrors, the lens and mirror yield more chromatic aberration, chromatic dispersion, and deformity due by portion of non paraxial rays, it induces visual fatigue or damage to eyesight for long viewing. Relatively speaking, the prisms and planar lens has no diopter existence, select the combination of prism and planar lens is better than that of the lens and curved mirror. For commercial application, the prism combination requires less space than the planar lens combination, the prism combination is more suitable for commercial product development. For commercial consideration, in order to reduce the thickness of the glasses it shall first reduce the thickness of the lenses which can be achieved by selection of large refractive index of optical prisms and lens or by structuring the asymmetry and difference of the apex angle of the opposite triangular prisms as in FIG. 8, FIG. 9, FIG. 10, FIG. 11. In order to reduce dispersion, it also can be achieved by selection of different refractive index, asymmetry or the angle difference of the opposite triangular prism as in FIG. 8, FIG. 9, FIG. 10, FIG. 11. By means of comparison the results and schemes of FIG. 2(a), FIG. 2(b), FIG. 2(c), FIG. 2(d), the FIG. 2(a) is the relatively less considering hypostereo structure; The FIG. 2(b) (by referring to FIG. 2(a)) further decreases parallax and reduces stereo sense, is a considered hyperstereo structure; The FIG. 2(c) is the relatively modest considering hypostereo structure with wide adaptability. The FIG. 2(d) (by referring to FIG. 2(b)) is the relatively modest considering hyperstereo structure.

The principle of the present invention is to convert refraction by optical lenses into parallax, to eliminate the negative effect to 3D sense by parallax when focusing on planar screen, to achieve optimal fusing of human binocular parallax by adjusting refraction. When viewing the screen scene by passing through the left-eye and right-eye lenses of the invented optical stereoscopic glasses, the screen scene yields an image on the left-eye retina by spatial displacement of the left-eye, another image on the right-eye retina by spatial displacement of the right-eye, the stereoscopic vision is yielded. Here specifically address the structure and design concept of several representative glasses.

At first, when watching through a transparent medium rather than air, due to the refraction effects of light, the scene is modified. As shown in FIG. 12, when watching through the rectangular prism “100” angled “40” to horizontal for a spatial triangle which is positioned at space point “10”,“11”,“12”, the spatial displacement occurs to the image of the triangle located at image point “20”,“21”,“22”. Decomposing the spatial displacement into horizontal and longitudinal coordinates in the reference frame, the horizontal axis represents the axis of eyes, longitudinal axis represents the vertical direction along the eye sight, the horizontal and longitudinal displacement is represented as “720” and “820”.

As shown in FIG. 13, when watching three objects “10”,“11”,“12” on screen “4” through the triangular prism “100” (with intersected two main optical surface, the intersectional apex angle labeled as “40”), the paralleled lights occurs deflection after by passing the triangular prism due by refraction, three images turn into “20”, “21”, “22” on the imaging screen “7”, after decomposition, the horizontal coordinates of displacement is represented by “720”, “721”, “722”, the longitudinal coordinates of displacement is represented by “810”. It is concluded that the greater the apex angle, the greater the deflection and the spatial displacement of the objects.

According to the refraction principles, the spatial displacement can be realized by proper combination of prisms. As shown in FIG. 14, it illustrates the combination of two opposite triangular prisms “100”, “200” labeled apex angle “40”, “50” on the left diagram, and “400”, “500” labeled apex angle “40”, “50” on the right diagram. When ray “1”, “2” passing through the combination of two opposite triangular prisms toward to the objects “10”, “11” on screen “4” of the left diagram, and “12”, “13” on screen “4” of the right diagram, the deflection occurred, the images “20”, “21” on screen “4” to the left diagram and the images “22”, “23” on screen “4” to the right diagram. By comparison, it is concluded that the greater the gap “9” vs. “8”, the greater the displacement “722”, “723” vs. “720”, “721”.

As shown in FIG. 15, it illustrates two sets of two opposite triangular prisms “100”, “200” which labeled apex angle “40”, “50” on the left diagram, and two opposite triangular prisms “400”, “500” which labeled apex angle “70”, “80” on the right diagram, when left ray “1L”, “2L” passing through the left two triangular prisms “100”, “200” toward to the objects “10”, “11” on screen “4” of the left diagram, and right ray “3R”, “4R” passing through the right two triangular prisms “400”, “500” toward to the objects “12”, “13” on screen “4” of the right diagram, the deflection occurred, the images “20”, “21” on left diagram and “22”, “23” on right diagram appear on screen “4”. By comparison, it is concluded that to various the gap “8” and “9”, the displacement “720”, “721” and “722”, “723” changes accordingly. The horizontal displacement “720”, “721” for the left prisms toward to the right, and “722”, “723” for the right prisms toward to the left, which represents the change of parallax.

As shown in FIG. 16, it illustrates the combination of two opposite triangular prisms “100”, “200” labeled apex angle “40”, “50” on the left diagram, and other two opposite triangular prisms “400”, “500” labeled apex angle “70”, “80” on the right diagram, when left ray “1L”, “2L” passing through the left two opposite triangular prisms toward to the objects “10”, “11” on screen “4” of the left diagram, and right ray “3R”, “4R” passing through the right two opposite triangular prisms toward to the objects “12”, “13” on screen “4” of the right diagram, the deflection occurred, the images “20”, “21” on left diagram and “22”, “23” on right diagram appear on screen “4”. By comparison, it is concluded that various the gap “8” and “9”, the displacement “720”, “721” and “722”, “723” changes accordingly. Inversing to FIG. 15, the horizontal displacement “720”, “721” for the left prism toward to the left, and “722”, “723” for the right prism toward to the right, which represents the change of parallax.

By comparison FIG. 15 and FIG. 16, the difference is just about swapping the right diagram and left diagram lenses, the orientation of the gap correlates to change the direction of parallax, the variable gap correlates to change the magnitude of parallax.

As shown in FIG. 17, two set of rectangular prisms are angled “40” and “70” to horizontal and thickness labeled “8” and “9”, when viewing the left scene points “10”, “11” and the right scene points “12”, “13” on screen plane “4” through the rectangular prisms, the image point “20”, “21” onto the image plane “6” for the left prism and “22”, “23” onto the image plane “7” for the right prism. By comparison, it is concluded that the greater the thickness “8” and “9”, the greater the displacement “720”, “721” and “722”, “723”. The horizontal displacement “720”, “721” for the left prism and “722”, “723” for the right prism, longitudinal displacement “821” for the left prism and “823” for the right prism, the horizontal displacement of left-eye towards to the left, the longitudinal displacement of right-eye to the right, which represent the FIG. 2(c) type of hypostereo vision.

as shown in FIG. 18, two set of rectangular prisms are angled “40” and “70” to horizontal and thickness labeled “8” and “9”, when viewing the left scene points “10”, “11” and the right scene points “12”, “13” on screen plane “4” through the rectangular prisms, the image point “20”, “21” onto the image plane “6” for the left prism and “22”, “23” onto the image plane “7” for the right prism. By comparison, it is also concluded that the greater the gap “8” and “9”, the greater the displacement “720”, “721” and “722”, “723”. the horizontal displacement “720”, “721” for the left prism and “722”, “723” for the right prism, longitudinal displacement “821” for the left prism and “823” for the right prism, the horizontal displacement of left-eye to the right, the horizontal displacement of right-eye to the left, which represent the FIG. 2(d) type of hyperstereo vision.

By comparison FIG. 17 and FIG. 18, it is just about swapping the right and left lenses, the orientation of the lenses correlates to change direction of parallax, the variable thickness correlates to change the magnitude of parallax.

Furthermore, to superimpose a triangular prism “300” angled “60” for the left and “600” angled “90” for the right of the two opposite triangular prisms in FIG. 15, as shown in FIG. 8, a set of triangular prisms “100” and “200” labeled apex angle “40”, “50” to horizontal and separated by the gap “8” in between the upper and lower triangular prism for the left lenses; a set of triangular prisms “400” and “500” labeled apex angle “70”, “80” to horizontal and separated by the gap of “9” in between the upper and lower triangular prism for the right lenses. When parallel beam “1L”, “2L” for the left lenses, “3R”, “4R” for the right lenses toward to the left scene points “10”, “11” and the right scene points “12”, “13” on screen plane “4” through the two sets of rectangular prisms, it is first refracted by the prism “100” and “200”, then by prism “300” to yield the horizontal displacement for the left lenses; and refracted by the prism “400” and “500”, then by prism “600” to yield the horizontal displacement for the right lenses. The image point “20”, “21” onto the image plane “6” for the left prisms and “22”, “23” onto the image plane “7” for the right prisms. By comparison, it is concluded that the greater the gap “8”, “9” and the greater the angle “60”, “90”, the greater the displacement of “720”, “721” and “722”, “723”. the horizontal displacement “720”, “721” for the left and “722”, “723” for the right prisms, longitudinal displacement “821” for the left prisms and “823” for the right prisms, the horizontal displacement of left-eye towards to the right, right-eye towards to the left, which represent the FIGS. 2(b),2(d) type of hyperstereo vision.

To superimpose a triangular prism “300” angled “60” for the left and “600” angled “90” for the right onto the outer surface of the two opposite triangular prisms in FIG. 16, As shown on FIG. 9, a set of triangular prisms “100” and “200” labeled apex angle “40”, “50” to horizontal and separated by the gap of “8” in between the upper and lower triangular prism for the left lenses; a set of triangular prisms “400” and “500” labeled apex angle “70”, “80” to horizontal and separated by the gap of “9” in between the upper and lower triangular prism for the right lenses. When parallel beam 1L, 2L of the left lenses, 3R, 4R of the right lenses toward to the scene points “10”, “11” and “12”, “13” on screen plane “4” through the two sets of rectangular prisms, it is refracted by the prism “100” and “200”, then by prism “300” to yield great horizontal displacement for the left lenses, it is also refracted by the prism “400” and “500”, then by prism “600” to yield great horizontal displacement for the right lenses. The image point “20”, “21” onto the image plane “6” for the left prisms and “22”, “23” onto the image plane “7” for the right prisms. By comparison, it concludes that the greater the gap “8” “9”, the greater the angle “60”,“90”, the greater the displacement of “720”,“721″ and”722″,“723”. the horizontal displacement of “720”, “721” for the left and “722”, “723” for the right prisms, and longitudinal displacement “821” for the left prisms and “823” for the right prisms, the horizontal displacement of left-eye towards to the left, right-eye to the right, which represent the FIGS. 2(a),2(c) type of hypostereo vision. By comparison of the structure of FIGS. 8, 9, which swaps the right and left lenses.

Similar analysis to FIG. 10 and FIG. 11, as in FIG. 10, it is easy concluded that the horizontal displacement of left-eye to the right, right-eye to the left, which represent the FIGS. 2(b),2(d) type of hyperstereo vision. As in FIG. 11, it is easy concluded that the horizontal displacement of left-eye towards to the left, right-eye towards to the right, which represent the FIGS. 2(a),2(c) type of hypostereo vision.

Summarizing above principles, to the parallel beam in vertical direction and the rectangular prism is angled to the horizontal, the greater the angle, the greater the refraction and spatial displacement; the thicker the prism, the greater the refraction and spatial displacement. To the two opposite triangular prisms as a set, the larger the gap, the greater the refraction and spatial displacement. On the outer surface of rectangular prism or a set of two opposite triangular prisms to superimpose a triangular prism (see FIG. 8, FIG. 9, FIG. 10, FIG. 11), it further changes the spatial displacement. According to formation mechanism of human parallax, the greater the horizontal displacement, the stronger the stereoscopic effect; the greater the longitudinal displacement, the stronger the depth perspective, the more weak of negative effect to 3D sense by binocular disparity when focusing on screen plane. When the horizontal displacement is large enough so that the parallax effect excessive the limitation of fusing human binocular vision, the distortion and ghosting image occurs, which causes eyestrain and eye injury. For curved mirror and optical lens, due to nonlinear relationship of the special displacement of scene points, it also results in image distortion besides causing refraction and spatial displacement. Unless it is a large curvature spherical mirror or lens (approximate horizontal or rectangular prism), or larger space between the lens and screen, small displacement effect occurs, distortion is not obvious. Among the prisms, the more the gaps, the greater the stereo sense, but the negative impact is when light passing through the prism will cause attenuation of a transmitted light, therefore, it should reduce the number of prisms or choose optical material with large transmissivity to ensure sufficient light intensity.

Taking above refraction principles and considering practicality of stereo glasses, the technique scheme of the invention is that, as shown in FIG. 8, FIG. 9, the left-eye and right-eye lenses are made of various prisms by given thickness, when watching the 2D movie or TV, depending on personal comfort requirement, the left lenses and right lenses can be adjusted with angle 41, 51 in the range of great than zero and less than 180 degree. The material of prism and lens are choice of optical glass, plastics, colloidal and other light weight, high transparency, high refractive index optical materials, including but not limited to solid, liquid, colloidal and other medium or combinations of them.

The stereoscopic glasses scheme of the invention (See FIGS. 2 (a), 2 (b), 2 (c), 2 (d)) can be extended, as shown in FIG. 19, 20, by adding another triangular prism onto the bottom surface of the lenses structure of FIG. 8 and FIG. 9. By comparison, the lenses structure in FIG. 19 further enhanced the hyperstereo viewing than in FIG. 8, in FIG. 20 enhanced the hypostereo viewing than in FIG. 9.

In summary, for given optical material, the thickness of the rectangular prism and the apex angle of triangular prism determine the horizontal displacement by refraction while light passing through it, changing of horizontal displacement modifies parallax, the magnitude of the horizontal displacement reflects the intensity degree of stereoscopic vision; changing of longitudinal displacement modifies spatial perspective, the magnitude of longitudinal displacement reflects the sense of space. It has been approved that, in consideration of comfort and practicality, by choice of light-weight, high transparency, high refractive index optical plastic material, the thickness of the lens in the range from 1 mm to 100 mm, the angle 41, 51 in the range of greater than zero but less than 180 degree, generate great effect of stereoscopic vision when viewing 2D movie or TV.

The present invention revels the best structure of optical stereoscopic glasses by assembling the rectangular prisms and triangular prisms, the optical surface of prism are flat and balanced by each other so that the invented stereoscopic glasses lens has no diopter, no chromatic dispersion, no chromatic aberration. The apex angle of triangular prisms shall be not too large, so as to avoid image distortion. By adjusting the prism pitch regulator located on both sides of the glasses frame, to achieve proper binocular disparity, to change or eliminate phenomenon of stereoscopy too small, too large, and ghosting image, to weaken the negative stereoscopic effect by parallax while focusing on screen plane. It does not cause eyestrain or eye injury when long watching movie or W.

What is claimed is:

1. An adjustable optical stereoscopic glasses device comprising left and right lenses, each lenses is the combination of optical prisms, lens, curved mirrors or planar mirrors.

2. The device of claim 1 wherein (i) the principle is to convert refraction by optical lens and prisms into parallax; (ii) to eliminate the negative effect to 3D sense by binocular parallax when accommodating or focusing on planar screen; and (iii) by adjusting the angle and separation among optical lens to achieve control over the refraction of light path.

3. The device of claim 1 wherein to form hypostereo and hyperstereo viewing by following specific rules to structure the combination of lens.

4. The device of claim 1 wherein the glasses frame has a designed structure to adjust the gap between the two opposite triangular prisms.

5. The device of claim 1 wherein the glasses frame has a designed structure to adjust the angle of outer triangular prism.
